(19) United States
(12) Patent Application Publication
(10) Pub. No.: US 2019/0197963 A1
(43) Pub. Date: Jun. 27, 2019

(54) DISPLAY DRIVING CIRCUIT AND BRIGHTNESS CONTROL METHOD APPLIED TO ORGANIC LIGHT-EMITTING DIODE PANEL

(71) Applicant: Raydium Semiconductor Corporation, Hsinchu (TW)

(72) Inventor: TSUNG-YAO PAI, Taichung City (TW)

(21) Appl. No.: 16/231,436

(22) Filed: Dec. 22, 2018

Related U.S. Application Data
(60) Provisional application No. 62/610,305, filed on Dec. 26, 2017.

(51) Int. Cl. G09G 3/3266

(52) U.S. Cl. CPC G09G 3/3266; G09G 2320/0626; G09G 2320/0233

(57) ABSTRACT

A display driving circuit, coupled to an OLED panel, includes a brightness controller, a light-emitting scan line adjusting circuit and a light-emitting scan line generator. The brightness controller provides a brightness controlling signal. The light-emitting scan line adjusting circuit includes a first counting unit, a second counting unit and an arrangement unit. The first counting unit provides a frame counting value. The second counting unit provides a light-emitting period counting value. The arrangement unit is coupled to the brightness controller, the first counting unit and the second counting unit and used to generate an adjusting signal according to the brightness controlling signal, the frame counting value and the light-emitting period counting value. The light-emitting scan line generator is coupled to the light-emitting scan line adjusting circuit and the OLED panel and used to generate light-emitting scan lines to the OLED panel according to the adjusting signal.

### BACKGROUND OF THE INVENTION

### 1. Field of the Invention

The invention relates to a display apparatus; in particular, to a display driving circuit and a brightness control method applied to an organic light-emitting diode (OLED) panel.

### 2. Description of the Prior Art

As shown in FIG. 1, the organic light-emitting diode panel PL can include (M*N) pixels P11˜PMN, and the display driving circuit of the organic light-emitting diode panel PL can include a data driver DD, a data writing scan line driver WSL and a light-emitting scan line driver LSL, and control the timing of data lines D1˜DM, data writing scan lines W1˜WN and light-emitting scan lines E1˜EN of the organic light-emitting diode panel PL respectively according to the timing controlling signal emitted by the timing controller TCON.

As shown in FIG. 2, the light-emitting scan line driver LSL includes a brightness controller 10 and a light-emitting scan line generator 12. The brightness controller 10 is coupled to the light-emitting scan line generator 12 and the light-emitting line generator 12 is coupled to the organic light-emitting diode panel PL. The light-emitting scan line driver LSL is used to control whether each line of the organic light-emitting diode panel PL emits light or not.

In fact, A lines of the organic light-emitting diode panel PL are generally selected as a basic unit of light-emitting scanning, where A is a positive integer. For example, a frame period FP in FIG. 3 includes a single light-emitting period LEP. If the light-emitting period LEP in FIG. 3 uses four lines as the basic unit of light-emitting scanning, then A=4. Wherein, “ON” represents the turn-on state; “OFF” represents the turn-off state; “W” represents the data writing state.

In order to improve the flicker phenomenon that may occur during light-emitting scanning, the frame period FP can include B light-emitting periods, where B is a positive integer. For example, each frame period FP in FIG. 4 and FIG. 5 includes four light-emitting periods LEP1˜LEP4, namely B=4, and there is a non-light-emitting period NLEP between two adjacent light-emitting periods (e.g., light-emitting periods LEP1˜LEP2), whereby the light-emitting region and the non-light-emitting region of the organic light-emitting diode panel PL can be controlled by a light-emitting scan method having fixed period.

However, according to the above, since the width of the conventional light-emitting period LEP must be a multiple of the A lines and the B light-emitting periods included in each frame period FP must be fixed, resulting in that the fineness of fine-tuning a ratio of the light-emitting region to the overall display region is limited, as shown in Table 1. [Table 1 is based on the fineness of 10 bits (1024 levels), and one frame period includes 1920 lines], which needs to be improved.

TABLE 1

| Ratio of the | Expected | Conventional | Conventional total width |
|---|---|---|---|
| light-emitting | average light- | average light- | of four light-emitting |
| region to the | emitting region | emitting region | regions in a frame period; |
| overall | in a frame | in a frame | Width of each of the four |
| display | period (Unit: | period (Unit: | light-emitting regions |
| region | line) | line) | (Unit: line) |
| 0/1024 | 0 | 0 | 0; 0/0/0/0 |
| 1/1024 | 2 | 0 | 0; 0/0/0/0 |
| 2/1024 | 4 | 0 | 0; 0/0/0/0 |
| 3/1024 | 5 | 0 | 0; 0/0/0/0 |
| 4/1024 | 8 | 0 | 0; 0/0/0/0 |
| 5/1024 | 9 | 16 | 16; 4/4/4/4 |
| 6/1024 | 11 | 16 | 16; 4/4/4/4 |
| 7/1024 | 13 | 16 | 16; 4/4/4/4 |
| 8/1024 | 15 | 16 | 16; 4/4/4/4 |
| 9/1024 | 17 | 16 | 16; 4/4/4/4 |
| . . . | . . . | . . . | . . . |

### SUMMARY OF THE INVENTION

Therefore, the invention provides a display driving circuit and a brightness control method applied to an organic light-emitting diode (OLED) panel to solve the above-mentioned problems of the prior arts.

A preferred embodiment of the invention is a display driving circuit. In this embodiment, the display driving circuit is coupled to an OLED panel. The display driving circuit includes a brightness controller, a light-emitting scan line adjusting circuit and a light-emitting scan line generator. The brightness controller provides a brightness controlling signal. The light-emitting scan line adjusting circuit includes a first counting unit, a second counting unit and an arrangement unit. The first counting unit provides a frame period counting value. The second counting unit provides a light-emitting period counting value. The arrangement unit is coupled to the brightness controller, the first counting unit and the second counting unit and used to generate an adjusting signal according to the brightness controlling signal, the frame period counting value and the light-emitting period counting value. The light-emitting scan line generator is coupled to the light-emitting scan line adjusting circuit and the OLED panel and used to generate light-emitting scan lines to the OLED panel according to the adjusting signal.

In an embodiment, the display driving circuit is a light-emitting scan line driver.

In an embodiment, during a light-emitting period, A light-emitting scan lines emit lights, wherein A is a positive integer.

In an embodiment, a frame period includes B light-emitting periods, wherein B is a positive integer.

In an embodiment, a unit includes C frame periods and an expected total width is total light-emitting region of the C frame periods, wherein C is a positive integer.

In an embodiment, values of A, B and C can be adjusted according to different OLED panels or requirements.

Another preferred embodiment of the invention is a brightness control method. In this embodiment, the brightness control method is applied to a display driving circuit. The display driving circuit is coupled to an OLED panel. The brightness control method includes following steps of: providing a brightness controlling signal; providing a frame period counting value; providing a light-emitting period counting value; generating an adjusting signal according to the brightness controlling signal, the frame period counting value and the light-emitting period counting value; and generating light-emitting scan lines to the OLED panel according to the adjusting signal.

Compared to the prior art, the display driving circuit and the brightness control method according to the invention can adjust the number of light-emitting lines in each light-emitting period, the number of light-emitting periods in each frame period, and the number of frame periods per unit according to different organic light-emitting diode panels or requirements; therefore, the fineness of fine-tuning the light-emitting brightness of the organic light-emitting diode panel can be increased to effectively improve the shortcoming of the prior art cannot finely adjust the light-emitting brightness of the organic light-emitting diode panel, and the flexibility of fine-tuning the brightness of organic light-emitting diode panels can be significantly increased.

The advantage and spirit of the invention may be understood by the following detailed descriptions together with the appended drawings.

### BRIEF DESCRIPTION OF THE APPENDED DRAWINGS

FIG. 1 illustrates a schematic diagram of the conventional organic light-emitting diode panel and its display driving circuit.

FIG. 2 illustrates a schematic diagram of the conventional light-emitting scan line driver coupled to the organic light-emitting diode panel.

FIG. 3 illustrates a schematic diagram of the frame period including a single light-emitting period.

FIG. 4 and FIG. 5 illustrate schematic diagrams of the frame period including a plurality of periodic light-emitting periods.

FIG. 6 illustrates a schematic diagram of the display driving circuit applied to the organic light-emitting diode panel in a preferred embodiment of the invention.

FIG. 7 illustrates a flowchart of the brightness control method applied to the organic light-emitting diode panel in another preferred embodiment of the invention.

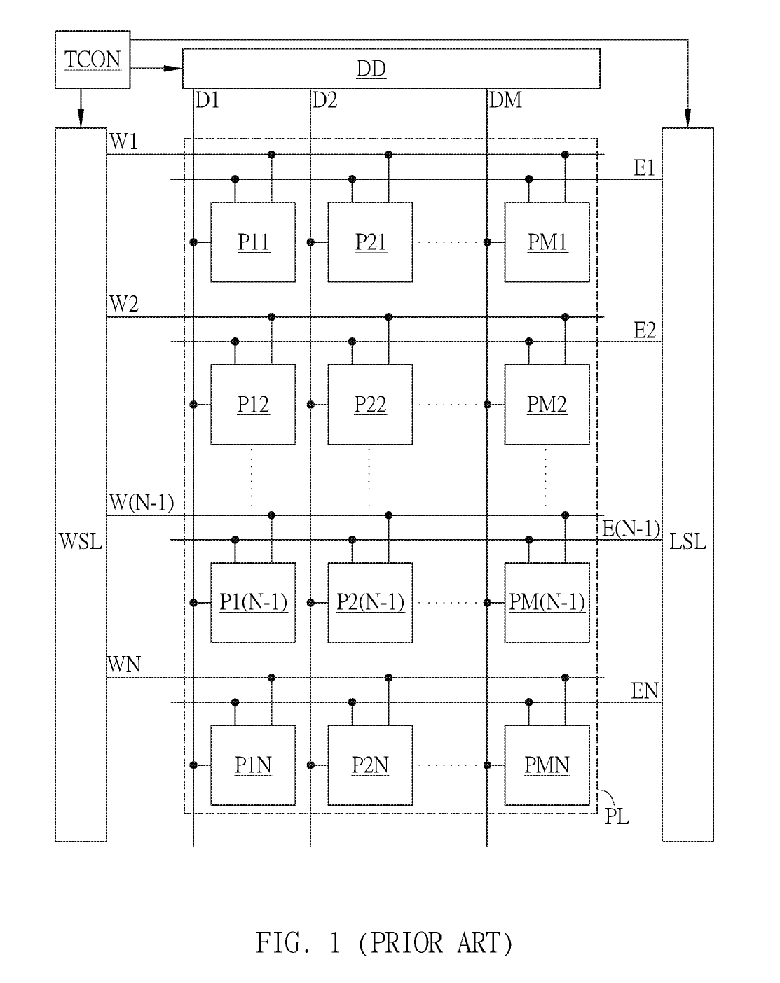

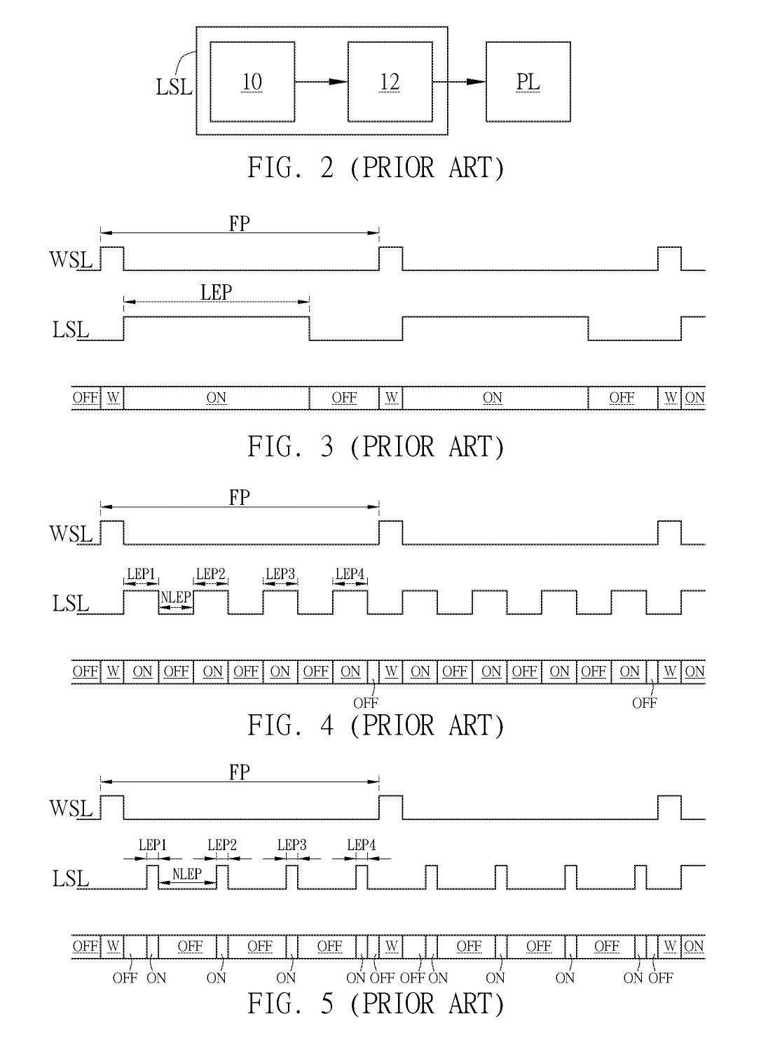

### DETAILED DESCRIPTION OF THE INVENTION

A preferred embodiment of the invention is a display driving circuit. In this embodiment, the display driving circuit is a light-emitting scan line driver, but not limited to this.

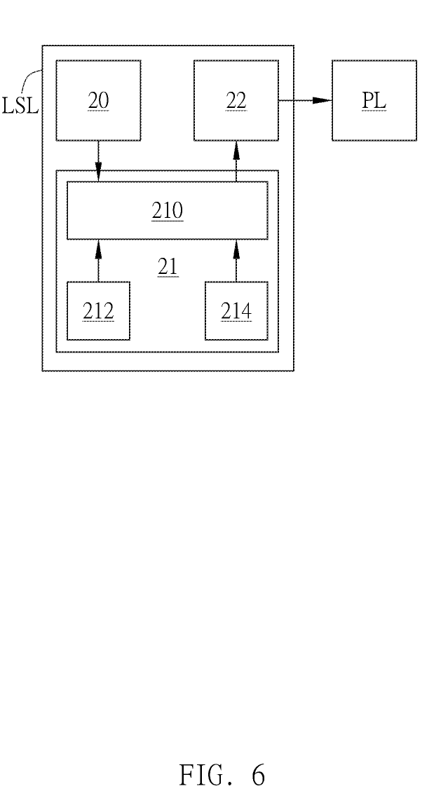

Please refer to FIG. 6. FIG. 6 illustrates a schematic diagram of the display driving circuit applied to the organic light-emitting diode panel in this embodiment.

As shown in FIG. 6, the display driving circuit LSL is coupled to the organic light-emitting diode panel PL. The display driving circuit LSL includes a brightness controller 20, a light-emitting scan line adjusting circuit 21 and a light-emitting scan line generator 22. The brightness controller 20 is coupled to the light-emitting scan line adjusting circuit 21; the light-emitting scan line adjusting circuit 21 is coupled to the brightness controller 20 and the light-emitting scan line generator 22 respectively; the light-emitting scan line generator 22 is coupled to the light-emitting scan line adjusting circuit 21 and the organic light-emitting diode panel PL respectively.

The main function of the brightness controller 20 is to set and control the brightness of the display to provide a brightness controlling signal to the light-emitting scan line adjusting circuit 21.

The light-emitting scan line adjusting circuit 21 includes an arrangement unit 210, a first counting unit 212 and a second counting unit 214. The arrangement unit 210 is coupled to the brightness controller 20, the first counting unit 212, the second counting unit 214 and the light-emitting scan line generator 22 respectively. The first counting unit 212 is coupled to the arrangement unit 210. The second counting unit 214 is coupled to the arrangement unit 210.

The first counting unit 212 is used to count frame periods to provide a frame period counting value to the arrangement unit 210. The second counting unit 214 is used to count light-emitting periods to provide a light-emitting period counting value to the arrangement unit 210.

When the arrangement unit 210 receives the brightness controlling signal, the frame period counting value and the light-emitting period counting value, the arrangement unit 210 will generate an adjusting signal to the light-emitting scan line generator 22 according to the brightness controlling signal, the frame period counting value and the light-emitting period counting value. Then, the light-emitting scan line generator 22 will generate light-emitting scan lines to the organic light-emitting diode panel PL according to the adjusting signal.

In practical applications, when the first counting unit 212 counts frame periods, if one unit includes C frame periods, then the expected total width is the total light-emitting region of the C frame periods, wherein C is a positive integer. When the second counting unit 214 counts light-emitting periods, if each frame period includes B light-emitting periods and during each light-emitting period, A light-emitting scan lines emit lights, wherein A and B are both positive integers.

It should be noted that, for the light-emitting scan line adjusting circuit 21 of the display driving circuit LSL of the invention, the light-emitting scan line adjusting circuit 21 can adjust values of the above-mentioned A, B, C according to different organic light-emitting diode panels or requirements respectively. That is to say, the number A of light-emitting scan lines in each light-emitting period, the number of light-emitting periods B in each frame period, and the number C of frame periods per unit can be adjusted according to different organic light-emitting diode panels or requirements.

For example, if every four frame periods (e.g., the first frame period˜the fourth frame period) is one unit (e.g., C=4), the expected total width will be the total light-emitting region of the four frame periods, and there are four light-emitting periods in each frame period (e.g., B=4). For different frame periods (e.g., the first frame period˜the fourth frame period), the number of light-emitting scan lines included in each light-emitting period (e.g., A) can be different.

If the fineness of 10 bits (1024 levels) is taken as an example, and a frame period is assumed to include 1920 lines, as shown in Table 2.

TABLE 2

| | | | Total width | Total width | Total width | Total width |
|---|---|---|---|---|---|---|
| | | | of four light-emitting | of four light-emitting | of four light-emitting | of four light-emitting |
| | | | regions in a | regions in a | regions in a | regions in a |
| | | Average | first frame period | second frame period | third frame period | fourth frame period |
| Ratio of the | Expected average | light-emitting | in the invention; | in the invention; | in the invention; | in the invention; |
| light-emitting | light-emitting | region in a | Width of each of the | Width of each of the | Width of each of the | Width of each of the |
| region to the | region in a | frame period | four light-emitting | four light-emitting | four light-emitting | four light-emitting |
| overall | frame period | in the invention | regions | regions | regions | regions |
| display region | (Unit: line) | (Unit: line) | (Unit: line) | (Unit: line) | (Unit: line) | (Unit: line) |
| 0/1024 | 0 | 0 | 0; 0/0/0/0 | 0; 0/0/0/0 | 0; 0/0/0/0 | 0; 0/0/0/0 |
| 1/1024 | 2 | 2 | 4; 4/0/0/0 | 0; 0/0/0/0 | 4; 4/0/0/0 | 0; 0/0/0/0 |
| 2/1024 | 4 | 4 | 4; 4/0/0/0 | 4; 4/0/0/0 | 4; 4/0/0/0 | 4; 4/0/0/0 |
| 3/1024 | 5 | 5 | 8; 4/0/4/0 | 4; 4/0/0/0 | 4; 4/0/0/0 | 4; 4/0/0/0 |
| 4/1024 | 8 | 8 | 8; 4/0/4/0 | 8; 4/0/4/0 | 8; 4/0/4/0 | 8; 4/0/4/0 |
| 5/1024 | 9 | 9 | 12; 4/4/4/0 | 8; 4/0/4/0 | 8; 4/0/4/0 | 8; 4/0/4/0 |
| 6/1024 | 11 | 11 | 12; 4/4/4/0 | 12; 4/4/4/0 | 12; 4/4/4/0 | 8; 4/0/4/0 |
| 7/1024 | 13 | 13 | 16; 4/4/4/4 | 12; 4/4/4/0 | 12; 4/4/4/0 | 12; 4/4/4/0 |
| 8/1024 | 15 | 15 | 16; 4/4/4/4 | 16; 4/4/4/4 | 16; 4/4/4/4 | 12; 4/4/4/0 |
| 9/1024 | 17 | 17 | 20; 8/4/4/4 | 16; 4/4/4/4 | 16; 4/4/4/4 | 16; 4/4/4/4 |
| . . . | . . . | . . . | . . . | . . . | . . . | . . . |

As shown in Table 2, in the invention, the light-emitting period widths of different frame periods (e.g., the first frame period˜the fourth frame period) can be different, that is to say, the number of light-emitting scan lines included in the light-emitting period can be different.

It should be noted that the average number of lines included in a light-emitting region of one frame period can be consistent with the expected average number of lines included in a light-emitting region of one frame period; that is to say, the invention can adjust the brightness of the OLED panel more finely, so that the disadvantages of the prior art shown in Table 1 that the brightness of the OLED panel cannot be finely adjusted under some light-emitting region ratios can be effectively improved, thereby the flexibility of fine-tuning the brightness of organic light-emitting diode panels can be significantly increased.

Another embodiment of the invention is a brightness control method. In this embodiment, the brightness control method is applied to the display driving circuit, and the display driving circuit is a light-emitting scan line driver, but not limited to this. The display driving circuit is coupled to the organic light-emitting diode panel.

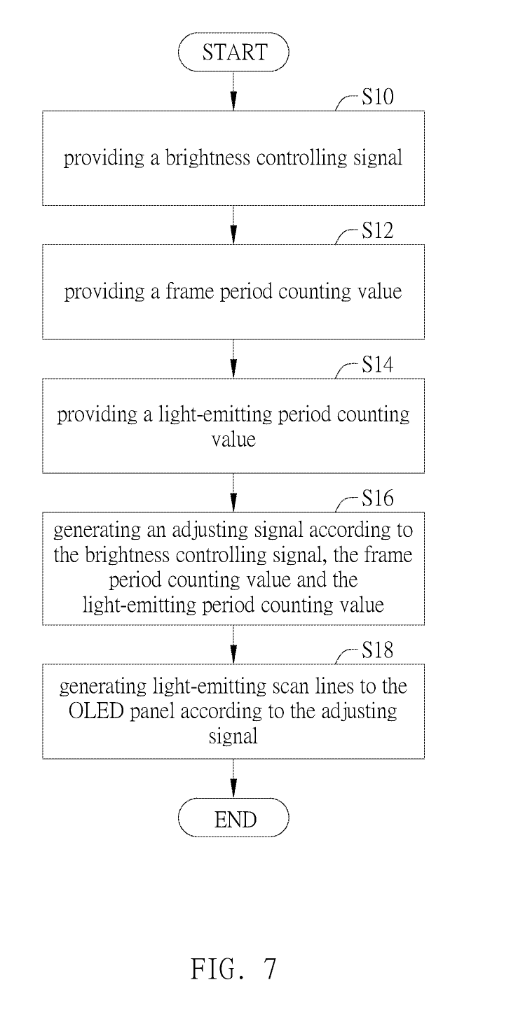

Please refer to FIG. 7. FIG. 7 illustrates a flowchart of the brightness control method applied to the organic light-emitting diode panel in this embodiment.

As shown in FIG. 7, the brightness control method applied to the organic light-emitting diode panel includes the following steps:

Step S10: providing a brightness controlling signal;

Step S12: providing a frame period counting value;

Step S14: providing a light-emitting period counting value;

Step S16: generating an adjusting signal according to the brightness controlling signal, the frame period counting value and the light-emitting period counting value; and

Step S18: generating light-emitting scan lines to the OLED panel according to the adjusting signal.

Compared to the prior art, the display driving circuit and the brightness control method according to the invention can adjust the number of light-emitting lines in each light-emitting period, the number of light-emitting periods in each frame period, and the number of frame periods per unit according to different organic light-emitting diode panels or requirements; therefore, the fineness of fine-tuning the light-emitting brightness of the organic light-emitting diode panel can be increased to effectively improve the shortcoming of the prior art cannot finely adjust the light-emitting brightness of the organic light-emitting diode panel, and the flexibility of fine-tuning the brightness of organic light-emitting diode panels can be significantly increased.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A display driving circuit, coupled to an OLED panel, the display driving circuit comprising:
a brightness controller, for providing a brightness controlling signal;
a light-emitting scan line adjusting circuit, coupled to the brightness controller, the light-emitting scan line adjusting circuit comprising:
a first counting unit, for providing a frame period counting value;
a second counting unit, for providing a light-emitting period counting value; and
an arrangement unit, coupled to the brightness controller, the first counting unit and the second counting unit respectively, for generating an adjusting signal according to the brightness controlling signal, the frame period counting value and the light-emitting period counting value; and
a light-emitting scan line generator, coupled to the light-emitting scan line adjusting circuit and the OLED panel respectively, for generating light-emitting scan lines to the OLED panel according to the adjusting signal.

2. The display driving circuit of claim 1, wherein the display driving circuit is a light-emitting scan line driver.

3. The display driving circuit of claim 1, wherein during a light-emitting period, A light-emitting scan lines emit lights, wherein A is a positive integer.

4. The display driving circuit of claim 1, wherein a frame period comprises B light-emitting periods, wherein B is a positive integer.

5. The display driving circuit of claim 1, wherein a unit comprises C frame periods and an expected total width is total light-emitting region of the C frame periods, wherein C is a positive integer.

6. The display driving circuit of claim 3, wherein values of A, B and C can be adjusted according to different OLED panels or requirements.

7. A brightness control method, applied to a display driving circuit coupled to an OLED panel, the brightness control method comprising following steps of:
providing a brightness controlling signal;
providing a frame period counting value;
providing a light-emitting period counting value;
generating an adjusting signal according to the brightness controlling signal, the frame period counting value and the light-emitting period counting value; and
generating light-emitting scan lines to the OLED panel according to the adjusting signal.

8. The brightness control method of claim 7, wherein the display driving circuit is a light-emitting scan line driver.

9. The brightness control method of claim 7, wherein during a light-emitting period, A light-emitting scan lines emit lights, wherein A is a positive integer.

10. The brightness control method of claim 7, wherein a frame period comprises B light-emitting periods, wherein B is a positive integer.

11. The brightness control method of claim 7, wherein a unit comprises C frame periods and an expected total width is total light-emitting region of the C frame periods, wherein C is a positive integer.

12. The brightness control method of claim 9 to claim 11, wherein values of A, B and C can be adjusted according to different OLED panels or requirements.

13. The display driving circuit of claim 4, wherein values of A, B and C can be adjusted according to different OLED panels or requirements.

14. The display driving circuit of claim 5, wherein values of A, B and C can be adjusted according to different OLED panels or requirements.

15. The brightness control method of claim 10, wherein values of A, B and C can be adjusted according to different OLED panels or requirements.

16. The brightness control method of claim 11, wherein values of A, B and C can be adjusted according to different OLED panels or requirements.
